(19) United States
(12) Patent Application Publication
(10) Pub. No.: US 2005/0043065 A1
(43) Pub. Date: Feb. 24, 2005

(54) Method for monitoring billable and non-billable call time on a wireless communication device

(76) Inventor: Joseph Bekanich, Boca Raton, FL (US)

Correspondence Address: Joseph Bekanich, 2519 N. Ocean Blvd., Boca Raton, FL, 33431, US

(21) Appl. No.: 10/885,653

(22) Filed: Jul. 8, 2004

Related U.S. Application Data
(60) Provisional application No. 60/485,128, filed on Jul. 8, 2003.

(51) Int. Cl. H04M 1/00; H04B 1/38

(52) U.S. Cl. 455/566; 455/556.2

(57) ABSTRACT

A method for monitoring call events for “bill-by-the-hour” professionals' activity on a wireless communication device, including a wireless telephone and a PDA device. This method detects, monitors and displays usage of each call event for a billable or non-billable call of an existing contact in the wireless communication devices' address book or database. This information is then provided to a server that contains related billing software to generate a bill for the contact.

This application claims the benefit of Provisional application 60/485,128 “Airtime for Professionals” filed on Jul. 8, 2003, this application is herein incorporated by reference in its entirety.

### FIELD OF THE INVENTION

This disclosure relates generally to wireless communication systems and more particularly to apparatus and method for monitoring and displaying time usage data for a cellular mobile communication device during a billing period. More particularly, this disclosure is related to monitoring, displaying capturing time usage data for a cellular mobile communication device for respective business and personal contacts.

### BACKGROUND OF THE INVENTION

This disclosure relates generally to wireless communication systems and more particularly method for monitoring and displaying call time usage data for “bill by the hour” professionals who use their cellular mobile communication device for business and personal use.

Mobile cellular phone technology is one of the fastest growing sectors of today's global economy, and it is expected that the use of cell phones will continue to grow dramatically in the future. Mobile professionals are becoming more reliant on their wireless communication devices to conduct business as well as conduct personal contact with others on a regular basis. For those professionals who are on a bill-by-the-hour, i.e. attorneys, independent contractors, engineers, etc., it is becoming more and more difficult and expensive to separate and track billable business related calls from other non-billable calls on a standard wireless phone bill which results in a loss of revenue and time.

It would be beneficial for mobile professionals to have a client call management software system that enabled their wireless mobile device to capture billable call events for easy billing management. Furthermore, this client call management software system can store and display the daily call activity as well as download the call activity to a PC for data synchronization, file management, printing via PC, application installation from a PC, and other utility functions allowing it to integrate effectively with PC and server-based data and billing software. The usefulness of a client call management software system would clearly offer numerous advantages for mobile professionals and their staff when billing, planning, managing and reviewing their wireless device client activity and phone charges.

### SUMMARY OF THE INVENTION

The time monitoring system, as described herein below, was developed to satisfy the needs of the subscriber as discussed above.

A wireless communication device comprising: a transmitter/receiver capable of transmitting and receiving a plurality of data signals; a microprocessor connected to the transmitter/receiver and configured to detect and display a call event on the screen of the device during and after a call event and provide monitoring information indicative of the call time length relating to a billable or non-billable timed call event of an existing person or persons in the wireless communication devices address book or database stored internally or externally of the wireless communication device, or incoming or outgoing call event that is a new call event that is not from a existing person or persons in the wireless communication devices address book or database stored internally or externally of the wireless communication device that will be captured for entry in the wireless communication devices address book or database stored internally or externally of the wireless communication device for modification at some future date.

The wireless communication device wherein the microprocessor is configured to provide current information indicative of a call event on the wireless communication device associated with a plurality of predetermined types of device events and instruct the display to continuously display the call event information of at least one type of device event of the plurality of predetermined types of device events.

The wireless communication device wherein the microprocessor is configured to instruct the display to display the call event information at a time when no device event is detected.

The wireless communication device wherein the microprocessor is configured to receive instructions from an operator of the wireless communication device to selectively remove call event information of a device event from the display and provide instructions to the display to selectively removing call event information of a device event from the display with a “hide” or “view” option.

The wireless communication device wherein the microprocessor is configured to determine a call event on the wireless communication device associated with one or multiple call events are occurring at the same time, to alert to the operator that one or more call events is occurring, an indicator will be activated that can be detected by the operator which can switch from one call event to another without loss of any call events or related information.

The method wherein the alert is at least one of an audio alert, a visual alert, voice alert and or a display screen within a display screen showing one or more call events simultaneously.

The wireless communication device wherein the microprocessor is configured to continuously capture call event duration of time for each single and or multiple call event of the detected call event during the occurrence of the detected call event and to provide a visual display to the operator on the wireless communication device display the call duration from start to finish of the call event, on the wireless communication device which communicates and synchronizes information wired or wirelessly between a computer and or server for updating, displaying and storage purposes.

The wireless communication device wherein the microprocessor is configured to provide a visual display of the call event information such as, but not limited to, call events billable time and denomination to the operator of the wireless communication device for a new or existing client and or personal call event.

The wireless communication device wherein the microprocessor is configured by the operator to define the billing parameters and or values to be displayed and or hidden on the display which are directly related to the call event duration.

The wireless communication device wherein the plurality of predetermined types of call events that include at least one of: call event including an call time length relating to a billable or non-billable timed call event of an existing person or persons in the wireless communication devices address book or database stored internally or externally of the wireless communication device, or incoming or outgoing call event that is a new call event that is not from a existing person or persons in the wireless communication devices address book or database stored internally or externally of the wireless communication device that will be captured for entry in the wireless communication devices address book or database stored internally or externally of the wireless communication device for modification at some future date.

The wireless communication device wherein a call event includes an capturing and displaying information in at least one of predefined fields: call parameters, client name, client number, case number, file number, call start time, call time end, call time total, billable rate, rounding of billable time indicator, multiple call indicator, new call indicator, personal call indicator, business call indicator, “is this call billable” display screen, total call event time, per client call event time, client call reminder, personal call reminder, client call notes, personal call notes and operator customizable fields.

The wireless communication device wherein the microprocessor is configured to detect and monitor call events for least one second of recorded time to an undefined period of time to provide call event information indicative of the call event of the wireless communication device which can be stored with in the wireless communication devices memory.

The wireless communication device, wherein an operator participating in a call event is prompted by a visual or audio alert if the new or existing incoming or outgoing call event is billable or non-billable to the operator and should be recorded to be defined at a later date.

A method of monitoring usage of a wireless communication device comprising the steps of: detecting and display a call event on the screen of the device during and after a call event and provide monitoring information indicative of the call time length relating to a billable or non-billable timed call event of an existing person or persons in the wireless communication devices address book or database stored internally or externally of the wireless communication device, or incoming or outgoing call event that is a new call event that is not from a existing person or persons in the wireless communication devices address book or database stored internally or externally of the wireless communication device that will be captured for entry in the wireless communication devices address book or database stored internally or externally of the wireless communication device for modification at some future date.

The method further comprising the steps of: to provide current information indicative of a call event on the wireless communication device associated with a plurality of predetermined types of device events and instruct the display to continuously display the call event information of at least one type of device event of the plurality of predetermined types of device events.

The method wherein the call event information is displayed at a time when a device event is not detected.

The method further comprising the step of: configured to receive instructions from an operator of the wireless communication device to selectively remove call event information of a device event from the display and provide instructions to the display to selectively removing call event information of a device event from the display with a “hide” or “view” option.

The method further comprising the steps of: to determine a call event on the wireless communication device associated with one or multiple call events are occurring at the same time, to alert to the operator that one or more call events is occurring, an indicator will be activated that can be detected by the operator which can switch from one call event to another without loss of any call events or related information.

The method wherein the alert is at least one of an audio alert, a visual alert, voice alert and or a display screen within a display screen showing one or more call events simultaneously.

The method wherein the microprocessor is configured to continuously capture call event duration of time for each single and or multiple call event of the detected call event during the occurrence of the detected call event and to provide a visual display to the operator on the wireless communication device display the call duration from start to finish of the call event, on the wireless communication device which communicates and synchronizes information wired or wirelessly between a computer and or server for updating, displaying and storage purposes.

The method wherein the microprocessor is configured to provide a visual display of the call event information such as, but not limited to, call events billable time and denomination to the operator of the wireless communication device for a new or existing client and or personal call event.

The method wherein the microprocessor is configured by the operator to define the billing parameters and or values to be displayed and or hidden on the display which are directly related to the call events duration.

The method wherein the plurality of predetermined types of call events that include at least one of: a call time length relating to a billable or non-billable timed call event of an existing person or persons in the wireless communication devices address book or database stored internally or externally of the wireless communication device, or incoming or outgoing call event that is a new call event that is not from a existing person or persons in the wireless communication devices address book or database stored internally or externally of the wireless communication device that will be captured for entry in the wireless communication devices address book or database stored internally or externally of the wireless communication device for modification at some future date.

The method wherein a call event includes an capturing and displaying information in at least one of predefined fields: call parameters, client name, client number, case number, file number, call start time, call time end, call time total, billable rate, rounding of billable time indicator, multiple call indicator, new call indicator, personal call indicator, business call indicator, “is this call billable” display screen, total call event time, per client call event time, client call reminder, personal call reminder, client call notes, personal call notes and operator customizable fields.

The method wherein the microprocessor is configured to detect and monitor call events for least one second of recorded time to an undefined period of time to provide call event information indicative of the call event of the wireless communication device which can be stored with in the wireless communication devices memory.

The method wherein an operator participating in a call event is prompted by a visual or audio alert if the new or existing incoming or outgoing call event is billable or non-billable to the operator and should be recorded to be defined at a later date.

A computer readable medium containing a program capable of causing a computer to perform a method of monitoring usage of a wireless communication device comprising the steps of: to detect and display a call event on the screen of the device during an after a call event and provide monitoring information indicative of the call time length relating to a billable or non-billable timed call event of an existing person or persons in the wireless communication devices address book or database stored internally or externally of the wireless communication device, or incoming or outgoing call event that is a new call event that is not from a existing person or persons in the wireless communication devices address book or database stored internally or externally of the wireless communication device that will be captured for entry in the wireless communication devices address book or database stored internally or externally of the wireless communication device for modification at some future date.

The computer readable medium, wherein the method further comprises the steps of: to provide current information indicative of a call event on the wireless communication device associated with a plurality of predetermined types of device events and instruct the display to continuously display the call event information of at least one type of device event of the plurality of predetermined types of device events.

The computer readable medium wherein the call event information is displayed at a time when a device event is not detected.

The computer readable medium, wherein the method further comprises the steps of: selectively remove call event information of a device event from the display and provide instructions to the display to selectively removing call event information of a device event from the display with a “hide” or “view” option.

The computer readable medium wherein the method further comprises the steps of: configured to determine a call event on the wireless communication device associated with one or multiple call events are occurring at the same time, to alert to the operator that one or more call events is occurring, an indicator will be activated that can be detected by the operator which can switch from one call event to another without loss of any call events or related information.

The computer readable medium, wherein the alert is at least one of an audio alert, a visual alert, voice alert and or a display screen within a display screen showing one or more call events simultaneously.

The computer readable medium of claim, wherein the method further configured to continuously capture call event duration of time for each single and or multiple call event of the detected call event during the occurrence of the detected call event and to provide a visual display to the operator on the wireless communication device display the call duration from start to finish of the call event, on the wireless communication device which communicates and synchronizes information wired or wirelessly between a computer and or server for updating, displaying and storage purposes.

The computer readable medium, configured to provide a visual display of the call event information such as, but not limited to, call events billable time and denomination to the operator of the wireless communication device for a new or existing client and or personal call event.

The computer readable medium, wherein the method comprises the steps configured by the operator to define the billing parameters and or values to be displayed and or hidden on the display which are directly related to the call events duration.

The computer readable medium wherein the plurality of predetermined types of call events that include at least one of: call event including a call time length relating to a billable or non-billable timed call event of an existing person or persons in the wireless communication devices address book or database stored internally or externally of the wireless communication device, or incoming or outgoing call event that is a new call event that is not from a existing person or persons in the wireless communication devices address book or database stored internally or externally of the wireless communication device that will be captured for entry in the wireless communication devices address book or database stored internally or externally of the wireless communication device for modification at some future date.

The computer readable medium wherein a call event includes an capturing and displaying information in at least one of predefined fields: call parameters, client name, client number, case number, file number, call start time, call time end, call time total, billable rate, rounding of billable time indicator, multiple call indicator, new call indicator, personal call indicator, business call indicator, “is this call billable” display screen, total call event time, per client call event time, client call reminder, personal call reminder, client call notes, personal call notes and operator customizable fields.

The computer readable medium wherein the method further is configured to detect and monitor call events for least one second of recorded time to an undefined period of time to provide call event information indicative of the call event of the wireless communication device which can be stored with in the wireless communication devices memory.

The computer readable medium of claim 31, wherein an operator participating in a call event is prompted by a visual or audio alert if the new or existing incoming or outgoing call event is billable or non-billable to the operator and should be recorded to be defined at a later date.

### BRIEF DESCRIPTION OF THE DRAWINGS

The accompanying drawings, which are incorporated in and form a part of the specification, together with the description serve to explain the principles of the invention. In the drawings:

FIG. 1 illustrates clientcall-manager software call report screen.

FIG. 2 illustrates an exemplary architecture of a wireless phone.

FIG. 3 illustrates the method of installing the software on to the device.

FIG. 4 illustrates the method of set-up and integration of the software.

FIG. 5 illustrates billing parameters set-up by the operator.

FIG. 6 illustrates the management of new calls by the software.

FIG. 7 illustrates the software and display activation process.

### DETAILED DESCRIPTION OF THE INVENTION

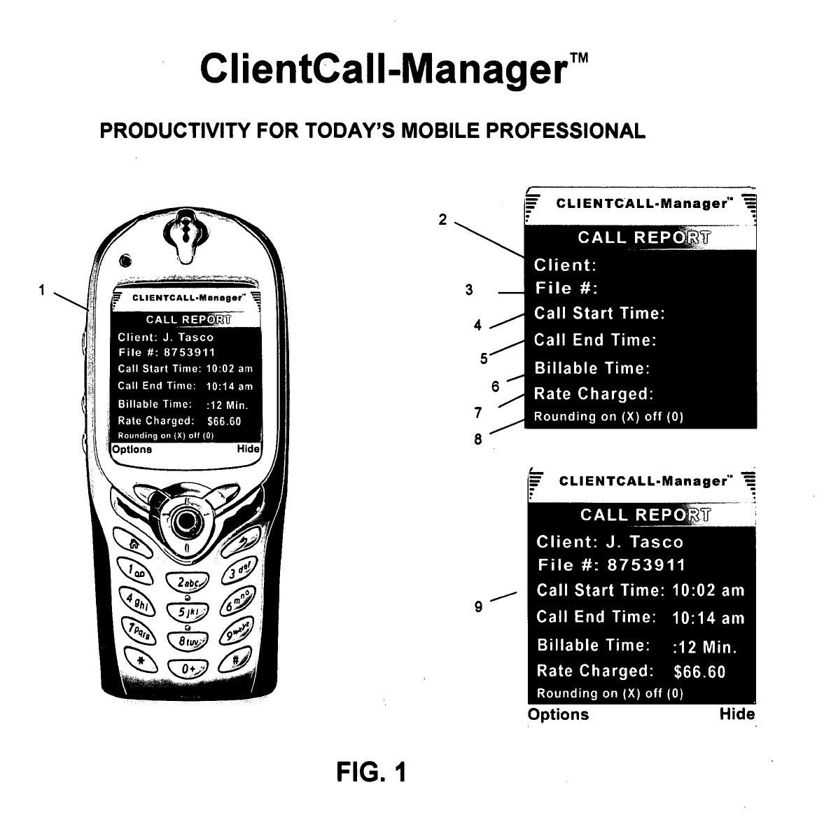

Referring now to FIGS. 1 through 7, example include specific software and call event management software, which is programmed directly into a conventional cell phone 10, to provide the various time management information.

FIG. 1 illustrates exemplary screen shots of cellular phone 1 having of client call management information displayed. The fields that will be displayed on the wireless device are: 2 client, 3 file #, 4 call start time, 5 call end time, 6 billable time, 7 rate charged, 8 rounding on or off to which supports billing parameters defined by the user (e.g. rounding to 1/10 hour billing). Call report 9 is an example of what call information an event would generate for an operator.

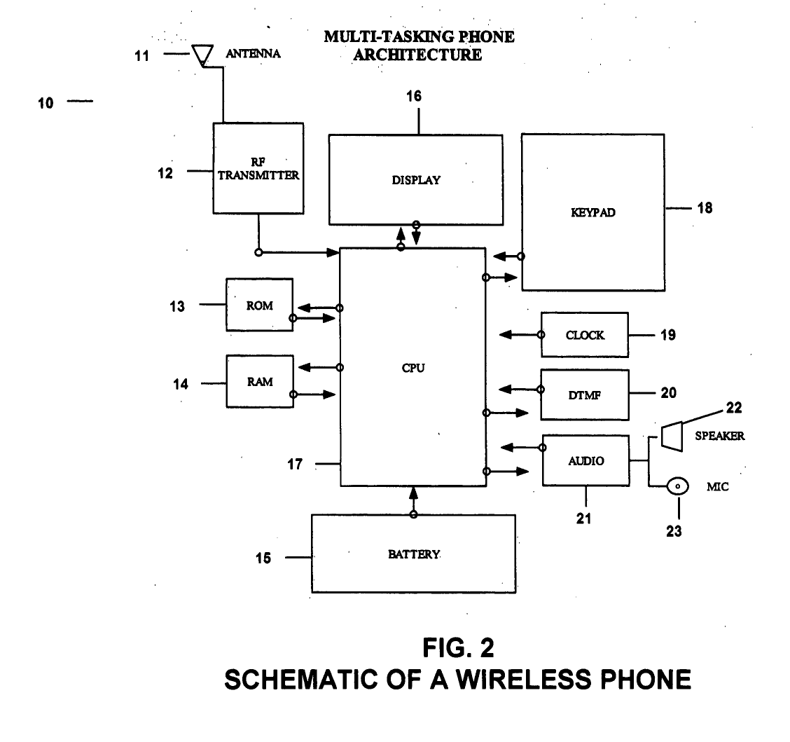

FIG. 2 illustrates an exemplary schematic of a wireless phone 10 that may be used. As illustrated in FIG. 2, a microphone 23 may receive sound (voice) from an operator and provide the sound as an analog signal to an audio unit 21, such as a VOCODER, which processes the sound signal and may provide the processed information as digitized audio data to a CPU 17. The voice data, formed by digitizing the audio signal, may contain spoken command information which causes the CPU 17 to perform various functions, such as dialing a call, and displaying information such phone numbers on display 16. The CPU 7 accesses ROM 13 and RAM 14 to retrieve program information and data to perform various functions such as, dialing a call and retrieving numbers from a phone book. The voice data does not contain command information, the digitized audio data may pass through (or bypass) CPU 17 to RF transmitter/receiver (transceiver) 12, for example, once a call is established through the wireless network. Clock 19 preferably provides clocking data to the CPU which may be used by the CPU 17 to monitor and display the time of day, the time a call is initiated and/or ended, and the duration of the call. Key pad 18 may be used by an operator to input commands to CPU 17 to perform various functions, such as placing a phone call, storing phone numbers in a phone book, and settings various parameters for control functions within the CPU 17. DTMF (dual tone multiple frequency) unit 20 provides frequencies and tones to CPU 17. RF transmitter/receiver 12 may be in the form of one or more digital transceivers which transmit and receive data through antenna 11. The transmitted data may include any form of data, such as voice data formed by digitizing the audio signal received from microphone 23 and operational data that may be used to control various functions of the CPU 17. The received data may also include any form of data, such as voice data from another telephone and operational data that may be used to control various functions of the CPU 17. Audio unit 21 and speaker 22 may convert received voice data to audio output that may be heard by an operator. Battery 15 may be provided to supply electrical power to the circuitry of the wireless phone.

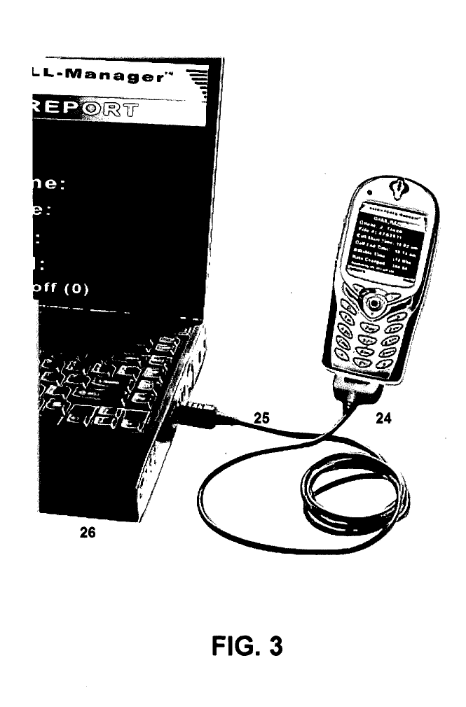

FIG. 3 the software program may be installed by way of a system illustrated in FIG. 3 which includes the cell phone 1 which has at least one data port 24 connected by way or a cable 25 to a computer 26, which is loaded with the select program that is to be installed in the cell phone 1. Alternatively, the program may be installed by a wireless system employing for example, cellular towers and/or satellites. Those of skill in the art will appreciate that the concepts disclosed herein may apply to any time usage devices, such as a wireless telephone and PDA devices

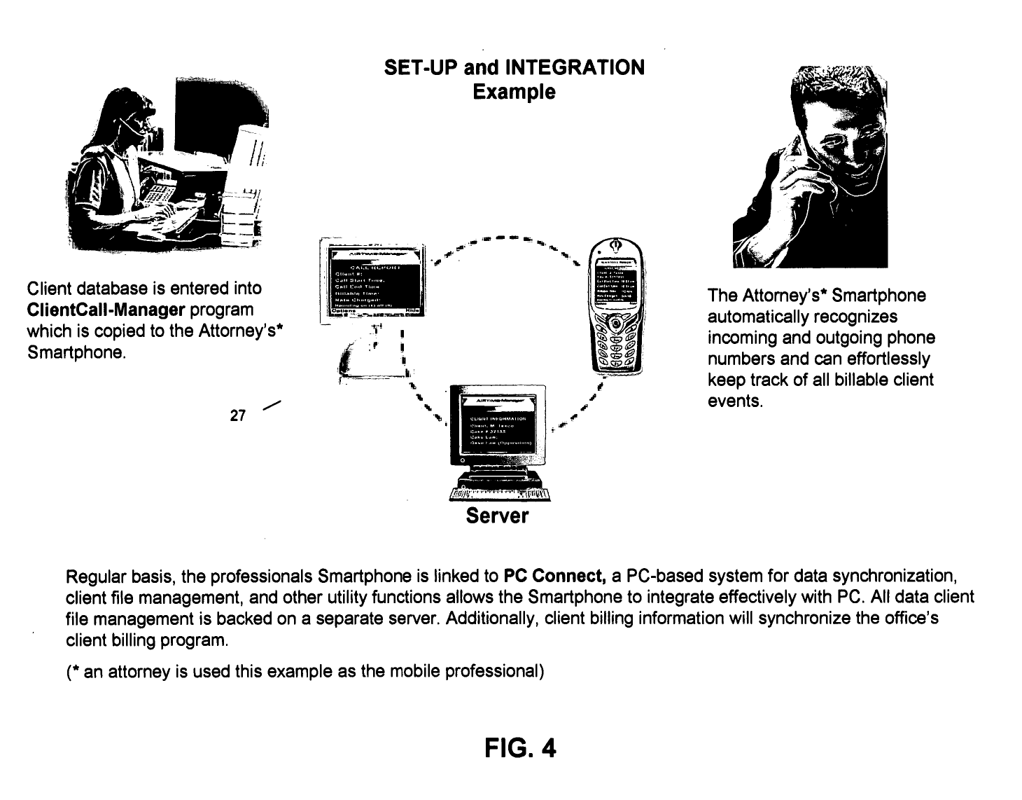

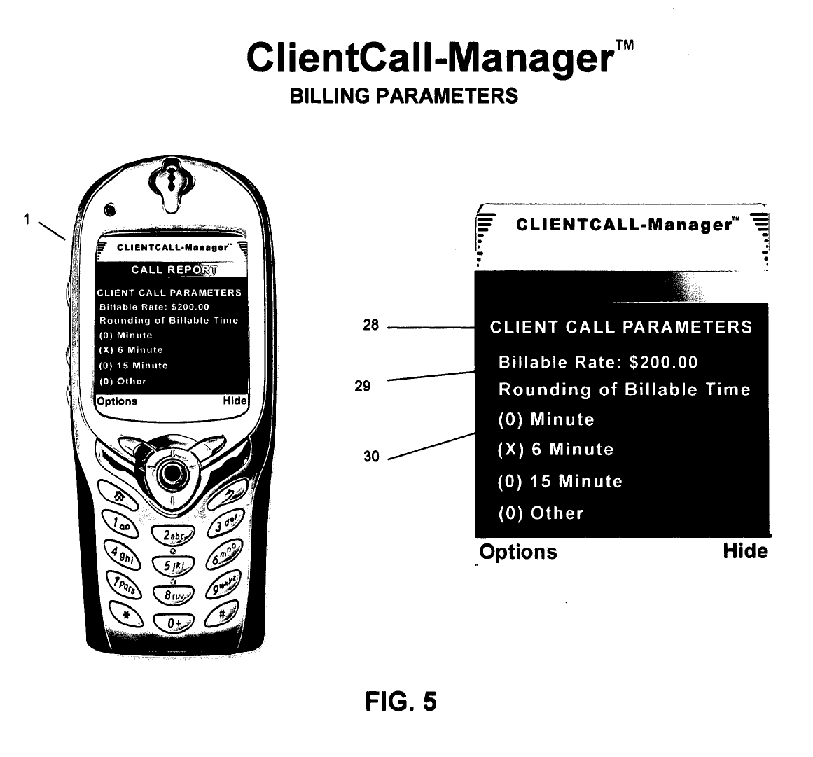

FIG. 4, illustrates 27, the set-up and integration process. FIG. 5, illustrates billing parameters 28 that are set up by the operator as a guideline for per call billable rates 29. Rounding of billable time 30 is set to various rounding up to the next time value to establish billable time.

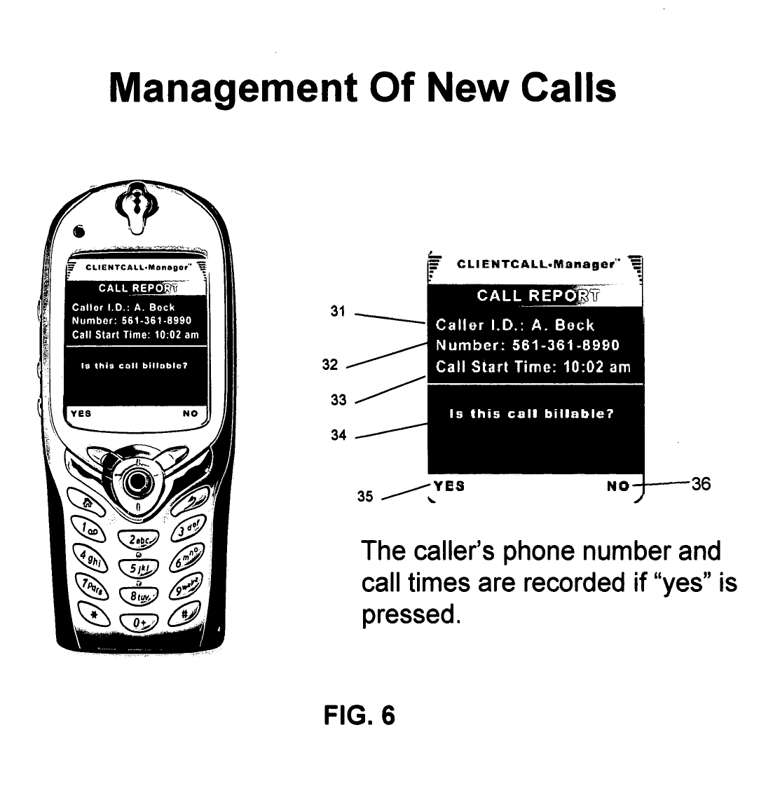

FIG. 6 illustrates the display for new calls that are not existing entries in the devices address book or database. Caller I.D. 31 and number 32 are displayed with call start time 33, and the “is this call billable?” 34 which are displayed simultaneously when a new call comes in. The method of capturing this call event is initialed by pressing the “yes” or “no” keys 35.

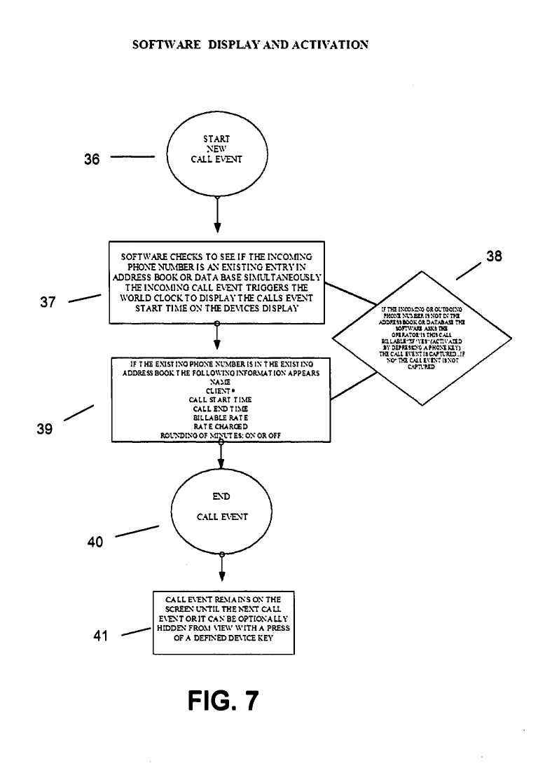

FIG. 7 illustrates the call process to activate the software and display when a new call event 36, occurs, the software 37 software checks to see if the incoming phone number is an existing entry in address book or data base simultaneously the incoming call event triggers the world clock to display the calls event start time on the devices display. If the incoming or outgoing phone number 32 is not in the address book or database the software asks the operator “is this call billable”? 34, if “yes” 35 (activated by depressing a phone key) the call event is captured . . . if “no” 36 the call event is not captured. if the existing phone number is in the existing address book the following information appears client name 2, file#3, call start time 4, call end time 5, billable time 6, rate charged 7, rounding of minutes: on or off 8, appear. End call event 40 enable the call data 41 to remain on the screen of the device 16, until the next call event occurs or hide the data from view by pressing key 36.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A wireless communication device comprising: a transmitter/receiver capable of transmitting and receiving a plurality of data signals; a microprocessor connected to the transmitter/receiver and configured to detect and display operator-defined call event parameters on the screen of the device during and after a call event and provide monitoring information indicative of the call time length relating to a billable or non-billable call event of contacts, groups, address book or database within the wireless communication device and displaying the monitored information during and after the call event on the screen of the wireless communication device.

2. The wireless communication device of claim 1, wherein the microprocessor is configured to provide current and or historical information indicative of a call event on the wireless communication device associated with a plurality of predetermined types of device events and instruct the display to continuously display the call event information of at least one type of device event of the plurality of predetermined types of device events.

3. The wireless communication device of claim 2, wherein the microprocessor is configured to instruct the display to display the historical information as a display screen and or “screensaver” at a time when a device event is not detected.

4. The wireless communication device of claim 2, wherein the microprocessor is configured to receive instructions from an operator of the wireless communication device to selectively add or remove call event information of a device billable or non-billable call event from the display and provide instructions to the display to selectively adding or removing call event information of a device event from the display with a “hide” or “view” option or command.

5. The wireless communication device of claim 1, wherein the microprocessor is configured to determine a call event on the wireless communication device associated with one or multiple billable or non-billable call events are occurring at the same time, and to alert to the operator that one or more billable or non-billable call event is occurring, an indicator will be activated that can be detected by the operator which can switch from one call event to another without loss of any call event or related information.

6. The method of claim 5 wherein the alert is at least one of an audio alert, a visual alert, voice alert and or a display screen within a display screen showing one or more call events simultaneously.

7. The wireless communication device of claim 5, wherein the microprocessor is configured to continuously capture call event duration of time for each single and or multiple call event of the detected call event during the occurrence of the detected call event and to provide a visual display to the operator on the wireless communication device display the call duration from start to finish of the call event, on the wireless communication device which can communicate and or synchronize information by wire or wirelessly to a computer and or server, to update a client profile, storage to automatically generate a bill for a client.

8. The wireless communication device of claim 7, wherein the microprocessor is configured to provide a visual display of the call event information such as but not limited to, call events billable time and denomination or billable rate defined by the to the operator of the wireless communication device for a new or existing client and or personal call event.

9. The wireless communication device of claim 5, wherein the microprocessor is configured by the operator to define the billing parameters and or values to be captured or recorded and display which are directly related to the call events duration which is directly reflected in the related client billing software values and client bill.

10. The wireless communication device of claim 5, wherein the plurality of predetermined types of call events that include at least one of: call event including an call time length relating to a billable or non-billable timed call event of an existing person or persons in the wireless communication devices contacts, groups, address book or database, or an incoming or outgoing call event that is a new call event that is not from a existing person or persons in the wireless communication devices contacts, groups, address book or database of the wireless communication device that can be captured or recorded for entry in the wireless communication device's contacts, groups, address book or database for modification at some future time.

11. The wireless communication device of claim 10, wherein a call event includes an capturing and displaying information in at least one of predefined fields: call parameters, client name, client number, case number, file number, call start time, call time end, call time total, billable rate, rounding of billable time indicator, multiple call indicator, new call indicator, personal call indicator, business call indicator, “is this call billable?” display screen, total call event time, per client call event time, client call reminder, personal call reminder, client call notes, personal call notes and operator customizable fields.

12. The wireless communication device of claim 11, wherein the microprocessor is configured to detect and monitor call events for least one second of recorded time to an undefined period of time to provide call event information indicative of the call event of the wireless communication device which can be stored with in the wireless communication devices memory or sent manually or automatically by SMS or text message to a computer or server for modification, storage, display or automatic bill generation from related billing generating software.

13. The wireless communication device of claim 10, wherein an operator participating in a single or multiple call event is prompted by a visual or audio alert if the new or existing incoming or outgoing call event is billable or non-billable to the operator and can optionally record the call event in the wireless communication device's memory which can be stored and modified at a later time.

14. A method of monitoring usage of a wireless communication device comprising the steps of: detecting and displaying operator-defined call event parameters on the screen of the device during and after a call event and provide monitoring information indicative of the call time length relating to a billable or non-billable call event of contacts, groups, address book or database within the wireless communication device and displaying the monitored information during and after the call event on the screen of the wireless communication device.

15. The method of claim 14 further comprising the steps of: providing current and or historical information indicative of a call event on the wireless communication device associated with a plurality of predetermined types of device events and instruct the display to continuously display the call event information of at least one type of device event of the plurality of predetermined types of device events.

16. The method of claim 15 further comprising the step of: being configured to instruct the display to display the historical information as a display screen and or “screensaver” at a time when a device event is not detected.

17. The method of claim 16 further comprising the step of: wherein the microprocessor is configured to receive instructions from an operator of the wireless communication device to selectively add or remove call event information of a device billable or non-billable call event from the display and provide instructions to the display to selectively adding or removing call event information of a device event from the display with a “hide” or “view” option or command.

18. The method of claim 14 further comprising the steps of: configured to determine a call event on the wireless communication device associated with one or multiple billable or non-billable call events are occurring at the same time, and to alert to the operator that one or more billable or non-billable call event is occurring, an indicator will be activated that can be detected by the operator which can switch from one call event to another without loss of any call event or related information.

19. The method of claim 18 wherein the alert is at least one of an audio alert, a visual alert, voice alert and or a display screen within a display screen showing one or more call events simultaneously.

20. The method of claim 18, wherein the microprocessor is configured to continuously capture call event duration of time for each single and or multiple call event of the detected call event during the occurrence of the detected call event and to provide a visual display to the operator on the wireless communication device display the call duration from start to finish of the call event, on the wireless communication device which can communicate and or synchronize information by wire or wirelessly to a computer and or server, to update a client profile, storage to automatically generate a bill for a client.

21. The method of claim 20, wherein the microprocessor is configured to provide a visual display of the call event information such as but not limited to, call events billable time and denomination or billable rate defined by the to the operator of the wireless communication device for a new or existing client and or personal call event.

22. The method of claim 18, wherein the microprocessor is configured by the operator to define the billing parameters and or values to be captured or recorded and display which are directly related to the call events duration which is directly reflected in the related client billing software values and client bill.

23. The method of claim 18, wherein the plurality of predetermined types of call events that include at least one of: call event including an call time length relating to a billable or non-billable timed call event of an existing person or persons in the wireless communication devices contacts, groups, address book or database, or an incoming or outgoing call event that is a new call event that is not from a existing person or persons in the wireless communication devices contacts, groups, address book or database of the wireless communication device that can be captured or recorded for entry in the wireless communication device's contacts, groups, address book or database for modification at some future time.

24. The method of claim 23, wherein a call event includes an capturing and displaying information in at least one of predefined fields: call parameters, client name, client number, case number, file number, call start time, call time end, call time total, billable rate, rounding of billable time indicator, multiple call indicator, new call indicator, personal call indicator, business call indicator, “is this call billable?” display screen, total call event time, per client call event time, client call reminder, personal call reminder, client call notes, personal call notes and operator customizable fields.

25. The method of claim 24, wherein the microprocessor is configured to detect and monitor call events for least one second of recorded time to an undefined period of time to provide call event information indicative of the call event of the wireless communication device which can be stored with in the wireless communication devices memory or sent manually or automatically by SMS or text message to a computer or server for modification, storage, display or automatic bill generation from related billing generating software.

26. The method of claim 18, wherein an operator participating in a single or multiple call event is prompted by a visual or audio alert if the new or existing incoming or outgoing call event is billable or non-billable to the operator and can optionally record the call event in the wireless communication device's memory which can be stored and modified at a later time.

27. A computer readable medium containing a program capable of causing a computer to perform a method of monitoring usage of a wireless communication device comprising the steps of: to detect and display operator-defined call event parameters on the screen of the device during and after a call event and provide monitoring information indicative of the call time length relating to a billable or non-billable call event of contacts, groups, address book or database within the wireless communication device and displaying the monitored information during and after the call event on the screen of the wireless communication device.

28. The computer readable medium of claim 27, wherein the method further comprises the steps of: to provide current and or historical information indicative of a call event on the wireless communication device associated with a plurality of predetermined types of device events and instruct the display to continuously display the call event information of at least one type of device event of the plurality of predetermined types of device events.

29. The computer readable medium of claim 28, wherein the method is configured to instruct the display to display the historical information as a display screen and or “screensaver” at a time when a device event is not detected.

30. The computer readable medium of claim 29, wherein the method is configured to receive instructions from an operator of the wireless communication device to selectively add or remove call event information of a device billable or non-billable call event from the display and provide instructions to the display to selectively adding or removing call event information of a device event from the display with a “hide” or “view” option or command.

31. The computer readable medium of claim 27, wherein the method is configured to determine a call event on the wireless communication device associated with one or multiple billable or non-billable call events are occurring at the same time, and to alert to the operator that one or more billable or non-billable call event is occurring, an indicator will be activated that can be detected by the operator which can switch from one call event to another without loss of any call event or related information.

32. The computer readable medium of claim 31, wherein the alert is at least one of an audio alert, a visual alert, voice alert and or a display screen within a display screen showing one or more call events simultaneously.

33. The computer readable medium of claim 31, wherein the method is configured to continuously capture call event duration of time for each single and or multiple call event of the detected call event during the occurrence of the detected call event and to provide a visual display to the operator on the wireless communication device display the call duration from start to finish of the call event, on the wireless communication device which can communicate and or synchronize information by wire or wirelessly to a computer and or server, to update a client profile, storage to automatically generate a bill for a client.

34. The computer readable medium of claim 33, configured to provide a visual display of the call event information such as but not limited to, call events billable time and denomination or billable rate defined by the to the operator of the wireless communication device for a new or existing client and or personal call event.

35. The computer readable medium of claim 31, wherein the method comprises the steps configured by the operator to define the billing parameters and or values to be captured or recorded and display which are directly related to the call events duration which is directly reflected in the related client billing software values and client bill.

36. The computer readable medium of claim 31, wherein the plurality of predetermined types of call events that include at least one of: call event including an call time length relating to a billable or non-billable timed call event of an existing person or persons in the wireless communication devices contacts, groups, address book or database, or an incoming or outgoing call event that is a new call event that is not from a existing person or persons in the wireless communication devices contacts, groups, address book or database of the wireless communication device that can be captured or recorded for entry in the wireless communication device's contacts, groups, address book or database for modification at some future time.

37. The computer readable medium of claim 36, wherein a call event includes an capturing and displaying information in at least one of predefined fields: call parameters, client name, client number, case number, file number, call start time, call time end, call time total, billable rate, rounding of billable time indicator, multiple call indicator, new call indicator, personal call indicator, business call indicator, “is this call billable?” display screen, total call event time, per client call event time, client call reminder, personal call reminder, client call notes, personal call notes and operator customizable fields.

38. The computer readable medium of claim 37, wherein the method further is configured to detect and monitor call events for least one second of recorded time to an undefined period of time to provide call event information indicative of the call event of the wireless communication device which can be stored with in the wireless communication devices memory or sent manually or automatically by SMS or text message to a computer or server for modification, storage, display or automatic bill generation from related billing generating software.

39. The computer readable medium of claim 31, wherein an operator participating in a single or multiple call event is prompted by a visual or audio alert if the new or existing incoming or outgoing call event is billable or non-billable to the operator and can optionally record the call event in the wireless communication device's memory which can be stored and modified at a later time.
